(19) United States
(12) Patent Application Publication
(10) Pub. No.: US 2019/0197261 A1
(43) Pub. Date: Jun. 27, 2019

(54) METHOD AND APPARATUS FOR PROTECTING CREDITABILITY OF SERVER HARDWARE BASED ON BASEBOARD MANAGEMENT CONTROLLER

(71) Applicant: WUHAN UNIVERSITY, Wuhan (CN)

(72) Inventors: Fajiang YU, Wuhan (CN); Jiuding HU, Wuhan (CN); Huanguo ZHANG, Wuhan (CN)

(21) Appl. No.: 16/015,170

(22) Filed: Jun. 21, 2018

(30) Foreign Application Priority Data
Dec. 26, 2017 (CN) 201711436623.3

(51) Int. Cl. G06F 21/73; G06F 21/44; G06F 21/81; H04L 9/32

(52) U.S. Cl. CPC G06F 21/73; G06F 21/44; G06F 21/602; H04L 9/3226; G06F 21/81

(57) ABSTRACT

A method for protecting the credibility of a server's hardware, the method including: setting reference values of credible components, encrypting the reference values, and writing the encrypted reference values to available record regions in the Field Replaceable Unit (FRU) of a server; obtaining information of target components of the server, and parsing and extracting needed data fields; and reading the encrypted reference values from the FRU, performing decryption operations, and determining whether the obtained component information is matched with the reference value; if they are not matched, one hardware component of the server is incredible, and a power-off operation is performed, otherwise the hardware of the server is credible, and the server is allowed to continue to run.

### CROSS-REFERENCE TO RELATED APPLICATIONS

Pursuant to 35 U.S.C. § 119 and the Paris Convention Treaty, this application claims foreign priority to Chinese Patent Application No. 201711436623.3 filed Dec. 26, 2017, the contents of which and any intervening amendments thereto are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, and Cambridge, Mass. 02142.

### BACKGROUND

The disclosure relates to the field of computer server technologies, and more particularly to a method and apparatus for protecting creditability of server hardware.

Creditability of server hardware is a basis for security of cloud computing and big data. A conventional method of protecting creditability of server hardware is mainly implemented by an administrator through manual check.

A Baseboard Management Controller (BMC) works independently of the processor (s), BIOS or operating system of one server and serves as a management subsystem running separately in a system. A user may obtain a server's information through IPMI interfaces or Redfish APIs locally or over a network to achieve an out-of-band management.

A Field Replaceable Unit (FRU) of a conventional server only stores information such as a name, a serial number and an ex-factory date of the server. An FRU memory is typically connected with a BMC via an I2C bus.

### SUMMARY

Disclosed is a method for protecting the credibility of a server's hardware, the method comprising:
1): setting reference values of credible hardware components, encrypting the reference values, and writing the encrypted reference values to available record regions in the Field Replaceable Unit (FRU) of a server;
2): measuring the credibility of a hardware component, obtaining information of a target hardware component of the server through the Baseboard Management Controller (BMC) then parsing the response byte stream and extracting needed target fields; and
3): reading the encrypted reference value from the FRU, then performing a decryption operation, and then completing a hardware credibility validation, and determining whether the obtained component information is matched with the reference value; if the obtained information of the component is not matched with the reference value, the hardware of the server is incredible, and a power-off operation is performed, otherwise the hardware of the server is credible, and the server is allowed to continue to run.

1) can be implemented as follows: obtaining a reference value from a user input, encrypting and storing the reference value according to the FRU data specification.

In more detail, 1) can be implemented as follows:

1.1): reading the credible reference value from a pre-stored file or an administrator's manual input through a graphical interface; encrypting one credible reference value separately, and the encryption algorithm may be SM4, AES, or 3DES, but it is not limited to a particular algorithm; adding a starting identifier and an ending identifier at the beginning and the end of the encrypted credible reference value of each component respectively to distinguish credible reference values of different components, the format of the identifier is self-defined as needed; adding a separator between each two encrypted credible reference values in the case of multiple reference values for one component; and last, structuring the encrypted and separator added reference values into the format of an FRU specification; and

1.2): using an IPMI command or a Redfish interface to write the processed credible reference values into the available record regions in the FRU of the server.

2) can be implemented as follows:

2.1): accessing System Management BIOS (SMBIOS) information through the BMC to obtain various information of a current hardware component of the server, by calling an IPMI raw command or a Redfish interface.

2.2): as the information of the hardware component obtained in the 2.1) is a byte data stream, filtering out irregular and irrelevant information to extract needed information.

3) can be implemented as follows:

3.1): before determining whether the obtained information of the current hardware component is credible, first reading the encrypted reference value from the FRU and performing information separation according to the identifiers, and then performing a decryption operation; and

3.2): completing a hardware credibility validation, and determining whether the obtained information of the component is matched with the reference value, if the obtained information of the component is not matched with the reference value, the hardware of the server is incredible, and a poweroff operation is performed, otherwise, the hardware of the server is credible, and the server is allowed to continue to run.

Further, disclosed is an apparatus for protecting credibility of server hardware, the apparatus comprising:
a reference value setting module located outside of BMC and configured to set reference values of credible hardware components, encrypt the reference values, and write the encrypted reference values into the available record regions in the Field Replaceable Unit (FRU) of a server, specifically writing the processed reference values should meet the FRU data specification, wherein the writing operation needs to be authorized;
a measuring module located inside of BMC and configured to measure the credibility of the hardware component, obtain information of a target hardware component of the server through the BMC by parsing the response byte data stream and extracting needed target fields; and
a validating module located inside of BMC and configured to first read the encrypted reference value from the FRU, then perform a decryption operation, and then complete a hardware credibility validation and determine whether the obtained information of the component is matched with the reference value; if they are not matched, one hardware component of the server is incredible and a poweroff operation is performed, otherwise, the hardware of the server is credible, and the server is allowed to continue to run.

Advantages of the method in the disclosure include the following: the creditability of the server hardware component can be checked in a simple, automatic, time-saving and cost-saving way without relying on BIOS/EFI and the operating system, which increased the security of the server hardware.

### BRIEF DESCRIPTION OF THE DRAWINGS

FIG. 1 illustrates a composition structure of the modules in the disclosure.

FIG. 2 is a flowchart illustrating the example in FIG. 1.

FIG. 3 illustrates the format of a CPU's reference value.

FIG. 4 illustrates the format of a RANI module's reference value.

FIG. 5 is a diagram illustrating a storage structure of the reference values of some hardware components in the disclosure.

FIG. 6 is a diagram illustrating the data formats of CPU reference values stored in the multi-records region of FRU.

FIG. 7 is a diagram illustrating the data formats of RANI module's reference values stored in the multi-records region of FRU.

FIG. 8 is a diagram illustrating the structure of SMBIOS information.

FIG. 9 is a schematic diagram illustrating the structure of CPU's information in SMBIOS.

FIG. 10 is a schematic diagram illustrating the structure of RAM module's information in SMBIOS.

### DETAILED DESCRIPTION

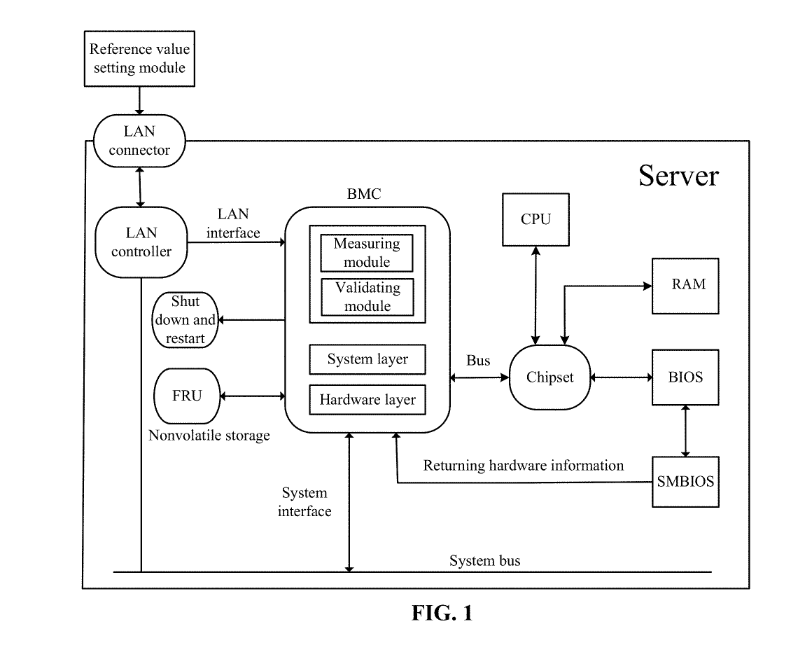

As shown in FIG. 1, an apparatus for protecting creditability of server hardware of the disclosure comprises three modules: a reference value setting module, a measuring module and a validating module. The reference value setting module is located outside the BMC, for example, located on a client connected with a BMC network. The measuring module and the validating module are located inside the BMC and belong to application programs of a BMC firmware system.

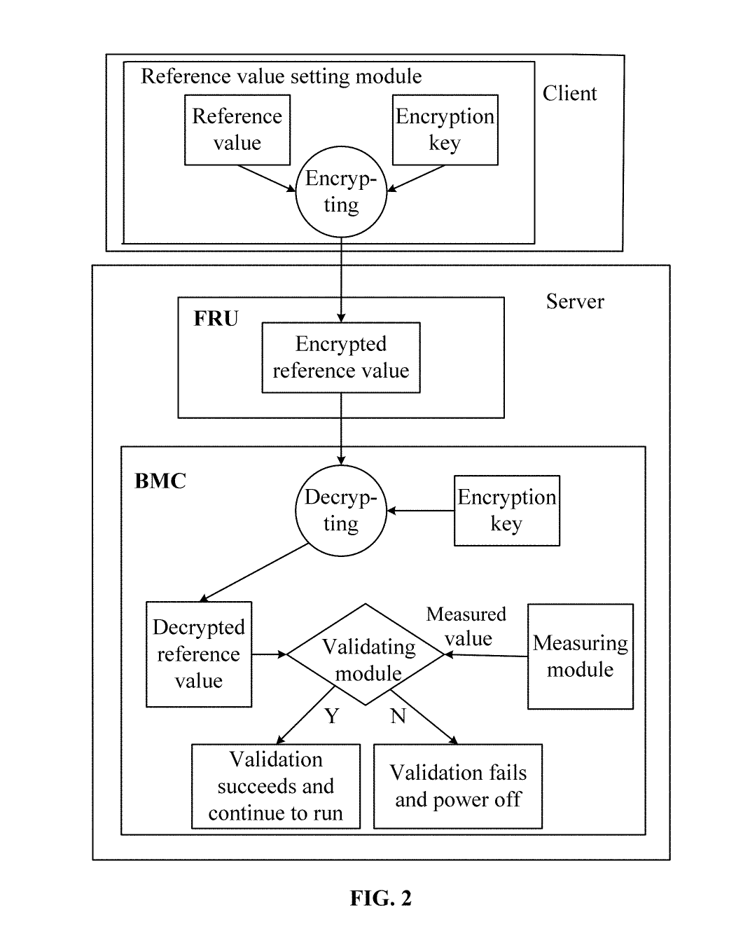

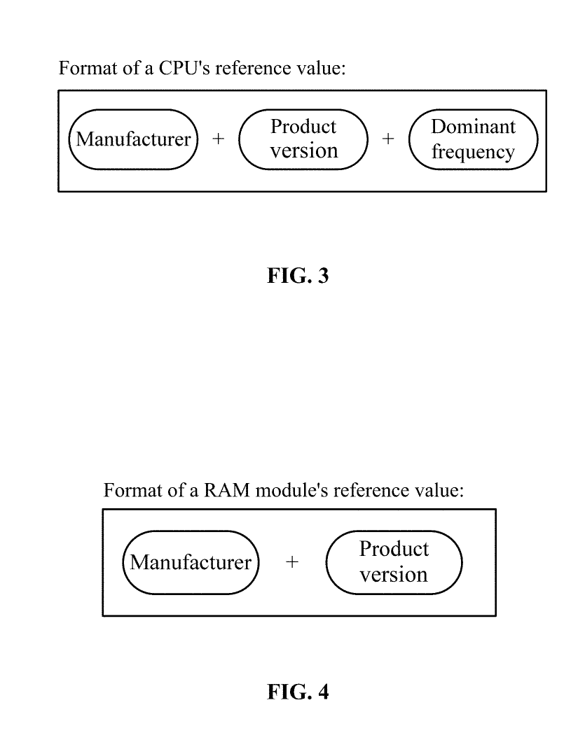

As shown in FIG. 2, the reference value setting module is first run; a user password of a server BMC is input, and some reference values of some hardware components of a server is read from a pre-stored file. The reference values may also be manually input by an administrator through a graphical interface. The reference values may include CPU and RANI module's information. The CPU reference value may comprise three fields: manufacturer, product version and frequency, and the RAM module reference value may comprise two fields: manufacturer and product version. The CPU and the RAM module's reference values are respectively stored in two text files, where one reference value is stored in a row. Each reference value is concatenated by multiple field contents and the fields are separated with a plus sign. FIG. 3 illustrates the format of a CPU's reference value, and FIG. 4 illustrates the format of a RANI module's reference value. One component may have multiple reference values.

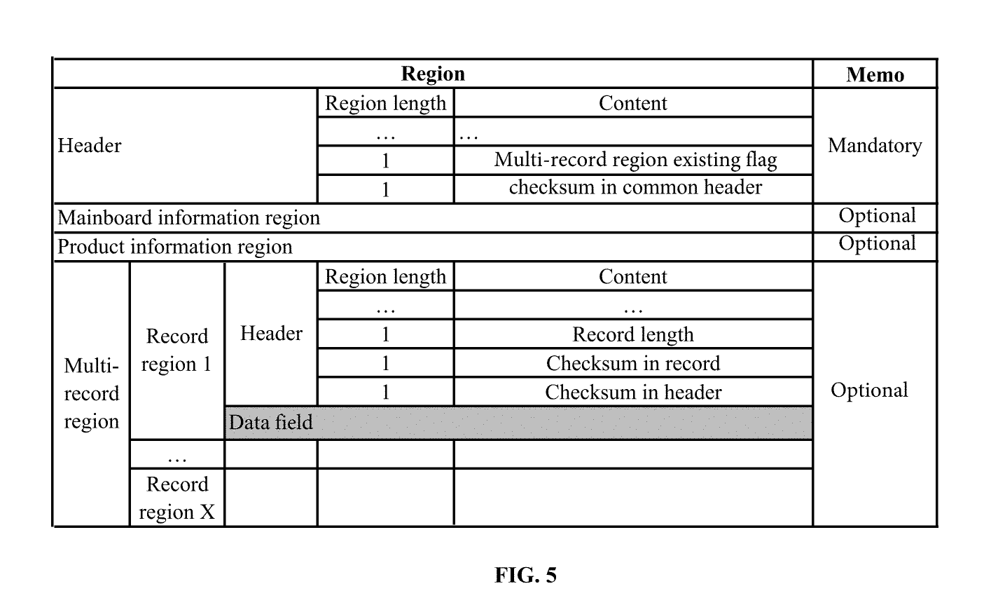

Next, the reference values are encrypted, the encryption algorithm can be, without limitation, SM4, AES, or 3DES. Each reference value is encrypted independently; the refence value may be padded before encryption, in order to have a length which can be divided by an encryption block size. The encrypted reference values are written into a multi-records region of an FRU based on the Platform Management FRU Information Storage Definition v1.0 of the Intel, as shown in FIG. 5. Each record in the multi-records region comprise a header and a data field. The length of the data field is represented by a byte in the header with its maximum being 255 bytes. Multiple encrypted reference values stored in the data field of each record.

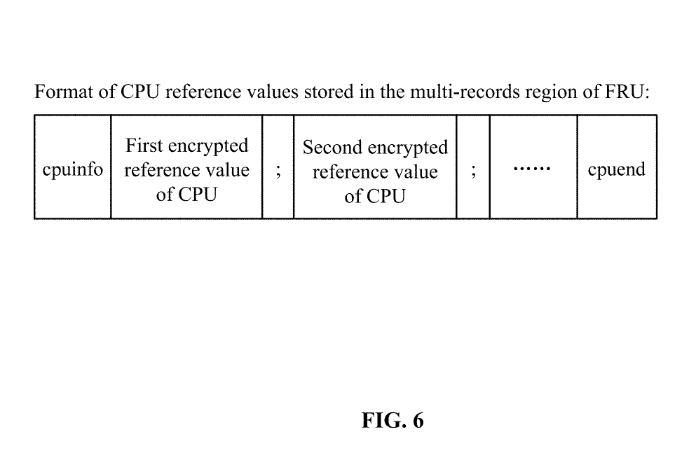

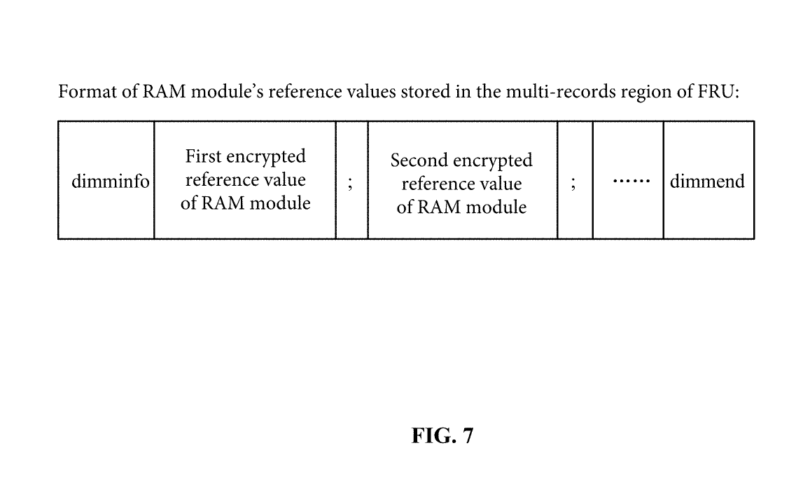

FIG. 6 and FIG. 7 illustrate a format of the data field, where an identifier ‘cpuinfo’ is added in front of the first encrypted CPU reference value, an identifier ‘cpuend’ is added after the last encrypted CPU reference value, an identifier ‘dimminfo’ is added in front of the first encrypted RANI module's reference value, and an identifier ‘dimmend’ is added after the last encrypted RANI module's reference value. A separator, for example, a semicolon, is added between two reference values. Then, the encrypted reference values are written into the data field of a record in the multi-records region of the FRU together with the identifiers and the separators. As shown in FIG. 5, in addition to the multi-records regions, the FRU further comprises a header, a mainboard information region and a product information region. After the encrypted reference values are written into the multi-records region, it is also required to modify the corresponding flag in the header to indicate that the multi-record region is used, and a checksum in the header also needs to be recalculated and rewritten.

An FRU write operation can be completed by calling an IPMI command using an IPMItool. However, the disclosure is not limited to an IPMI interface and a Redfish interface may also be used. A basic format of an FRU operation command of IPMItool is as follows: ipmitool -I interface options fm command, where interface may be ‘open’, ‘lan’ or ‘lanplus’. If ‘open’ is used, there is no the parameter ‘options’, otherwise, the parameter ‘options’ is -H ipaddress -U username -P password. The command may be write, read, edit, print and the like.

The FRU data is read via a read command first, saved as a binary file then its header and multi-records regions are modified, and next, the modified binary file is written into the FRU. A read command and a write command are used where the format of the read command is as follows: read <fru id><fru file>, and the format of the write command is as follows: fru write <fru id><fru file>. A specific read command used in the example is as follows: ipmitool -I lanplus -H ip -U username -P password fru read 0/root/fru.bin.

As shown in FIG. 5, after the credible values are written into the FRU, the example runs the measuring module to access System Management BIOS (SMBIOS) information through the BMC to obtain various information of a current hardware component of the server. Content returned is byte stream data, and the CPU information and the RAM module information are parsed and extracted according to the SMBIOS Reference specification v3.1.0.

An IPMI raw command can be called by using the IPMItool so as to obtain information of a hardware component by accessing the SMBIOS through the BMC. However, the disclosure is not limited to using an IPMI interface and a Redfish interface may also be used. The basic format of the IPMItool raw command is as follows: ipmitool -I interface options raw netfn cmd data, where interface may be ‘open’, ‘lan’ or lanplus'. If ‘open’ is used, there is no the parameter ‘options’, otherwise, the parameter ‘options’ is -H ipaddress -U username -P password. Netfn identifies messages returned by different IPMI commands and divides the messages into different groups. cmd is a unique single-byte instruction, and data provides an additional parameter (if any) for a request or response.

The command format of reading CPU's information and RAM module's information of the server can be as follows: ipmitool -I lanplus -H ip -U username -P password raw 0x3e 0x23 0x01 0xff 0x00, where netfn=0x3e, cmd=0x23, data=0x01 0xff 0x00; the first byte of the ‘data’ represents a data region, 01h means an SMBIOS region, the second byte represents a length of read data, 0xff means a length of 255 bytes, and the third and the fourth bytes represent offsets. All SMBIOS contents can be read by adjusting the offsets.

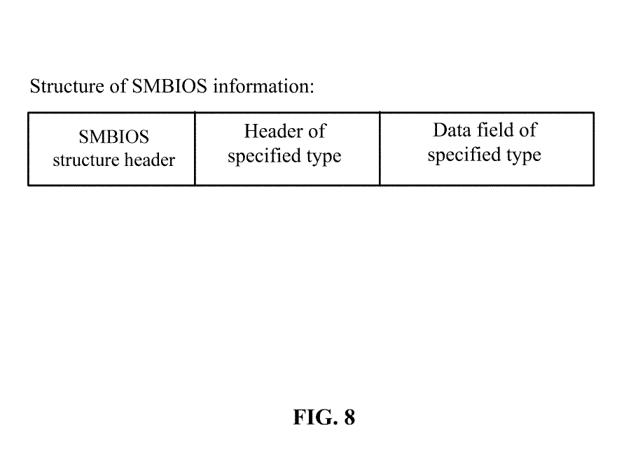

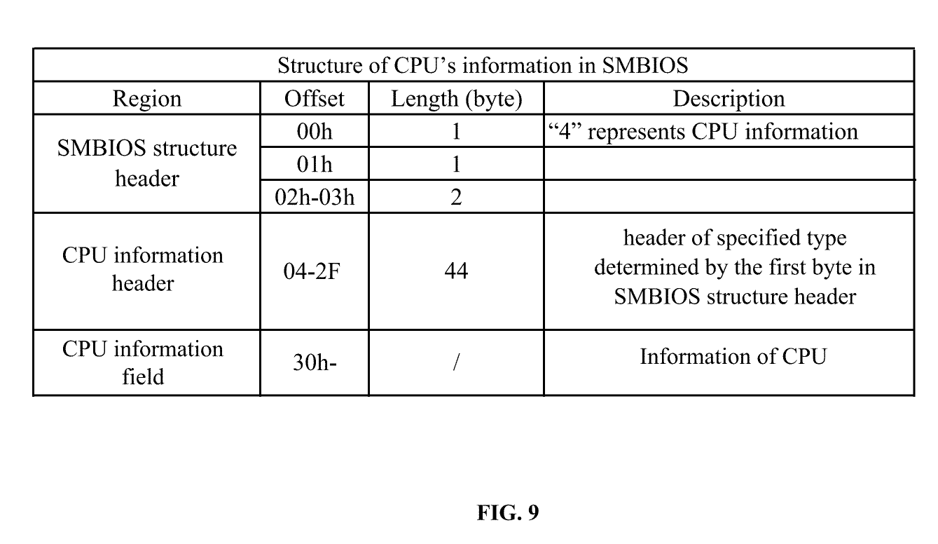

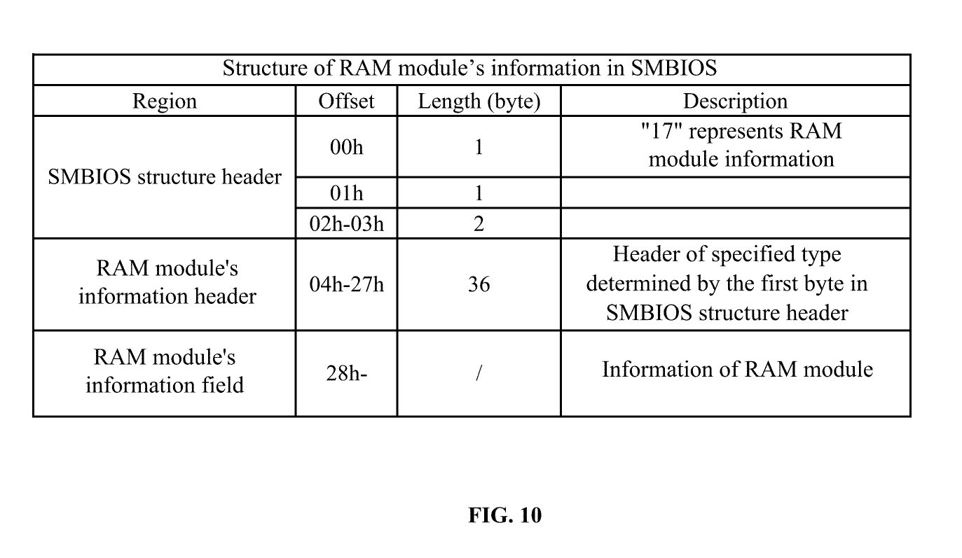

The data returned by the above command for accessing the SMBIOS is in a byte stream format. The data is parsed by mainly referring to the System Management BIOS (SMBIOS) Reference specification v3.1.0; and as shown in FIG. 8, the structure of SMBIOS contents mainly comprises three parts, i.e. an SMBIOS header, a header of a specified type and a data fields of the specified type. The SMBIOS header is four bytes long in total, where the first byte indicates the type, 4 means CPU information and 17 means RAM module information; the second byte represents the total length of the SMBIOS header and the header of a specified type; the third and fourth bytes represent a serial number of a specified type. A target component's information can be extracted from the data fields. FIG. 9 schematically illustrates the structure of CPU's information in SMBIOS, and FIG. 10 schematically illustrates the structure of RANI module's information in SMBIOS.

After the measuring module obtains information of some current components of the server, the validating module starts to run. The validating module reads the encrypted reference values from the multi-records region of the FRU. The CPU reference values can be separated from the RAM module according to identifiers ‘cpuinfo’, ‘cpuend’, ‘dimminfo’ and ‘dimmend’, then the reference values can be divided according to separators (semicolons), and next the reference values are decrypted one by one, and the padded bytes can be removed. Then, the decrypted values are compared with the information of the component extracted by the measuring module. If they are matched, the validation succeeds and the hardware of the server is credible, and the server may continue running. Otherwise, the hardware is not credible, and the validating module calls a BMC interface to perform a power-off operation on the server.

The IPMI command can be called by use of an IPMItool to perform a power-off operation on the server; however, the disclosure is not limited to using the IPMItool or the IPMI interface. The specific command used can be ipmitool -I lanplus -H ip -U username -P password chassis power off.

Unless otherwise indicated, the numerical ranges involved include the beginning and end values. It will be obvious to those skilled in the art that changes and modifications may be made, and therefore, the aim in the appended claims is to cover all such changes and modifications.

What is claimed is:

1. A method for protecting the credibility of a server's hardware, the method comprising:
1): setting reference values of credible hardware components, encrypting the reference values, and writing the encrypted reference values to available record regions in the Field Replaceable Unit (FRU) of a server;
2): measuring the credibility of a hardware component, obtaining information of a target hardware component of the server through the baseboard management controller (BMC), then parsing and extracting needed target fields from the byte data stream; and
3): reading the encrypted reference value from the FRU, then performing a decryption operation, and then completing a hardware credibility validation, and determining whether the obtained component information is matched with the reference value; if the obtained information of the component is not matched with the reference value, the hardware of the server is incredible, and a power-off operation is performed, otherwise the hardware of the server is credible, and the server is allowed to continue to run.

2. The method of claim 1, wherein 1) is implemented as follows: obtaining a reference value from a user input, encrypting and storing the reference value according to the FRU data specification.

3. The method of claim 2, wherein 1) is implemented as follows:
1.1): inputting a BMC user password of a server, and reading the credible reference value of the hardware component of the server from a pre-stored file, wherein the credible reference value is not limited to being input by obtaining from a file and is also manually input by an administrator through a graphical interface; encrypting one credible reference value separately; adding a starting identifier and an ending identifier at the beginning and the end of the encrypted credible reference value of each component respectively to distinguish credible reference values of different components, the format of the identifier is self-defined as needed; adding a separator between each two encrypted credible reference values in the case of multiple reference values for one component; and last, structuring the encrypted and separator added reference values into the format of an FRU specification; and
1.2): using an IPMI command or a Redfish interface to write the processed credible reference values into the available record regions in the FRU of the server.

4. The method of claim 1, wherein 2) is implemented as follows:
2.1): accessing System Management BIOS (SMBIOS) information through the BMC to obtain various information of a current hardware component of the server, by calling an IPMI raw command or a Redfish interface; and
2.2): when the information of the hardware component obtained in the 2.1) is a byte data stream, filtering out irregular and irrelevant information to extract needed information.

5. The method of claim 1, wherein 3) is implemented as follows:
3.1): before determining whether the obtained information of the current hardware component is credible, first reading the encrypted reference value from the FRU and performing information separation according to the identifiers, and then performing a decryption operation; and
3.2): completing a hardware credibility validation, and determining whether the obtained information of the component is matched with the reference value, if the obtained information of the component is not matched with the reference value, the hardware of the server is incredible, and a poweroff operation is performed, otherwise, the hardware of the server is credible, and the server is allowed to continue to run.

6. An apparatus for protecting credibility of server hardware, the apparatus comprising:
a reference value setting module located outside of BMC and configured to set reference values of credible hardware components, encrypt the reference values, and write the encrypted reference values into the available record regions in the Field Replaceable Unit (FRU) of a server;
a measuring module located inside of BMC and configured to measure the credibility of the hardware component, obtain information of a target hardware component of the server through the BMC by parsing the response byte data stream and extracting needed target fields; and
a validating module located inside of BMC and configured to first read the encrypted reference value from the FRU, then perform a decryption operation, and then complete a hardware credibility validation and determine whether the obtained information of the component is matched with the reference value; if they are not matched, one hardware component of the server is incredible and a poweroff operation is performed, otherwise, the hardware of the server is credible, and the server is allowed to continue to run.

7. The apparatus of claim 6, wherein the reference value setting module is configured to obtain reference values from an input, encrypt and write the reference values according to an FRU data specification; and the writing operation needs to be authorized.
